(19) United States
(12) Patent Application Publication
(10) Pub. No.: US 2017/0205798 A1
(43) Pub. Date: Jul. 20, 2017

(54) SCREW FASTENING DEVICE WHICH USES ROTATIONAL FORCE OUTPUT FROM ROBOT

(71) Applicant: FANUC CORPORATION, Yamanashi (JP)

(72) Inventor: Yuki Ishii, Yamanshi (JP)

(73) Assignee: FANUC CORPORATION, Yamanashi (JP)

(21) Appl. No.: 15/407,726

(22) Filed: Jan. 17, 2017

(30) Foreign Application Priority Data
Jan. 18, 2016 (JP) 2016-007015

(51) Int. Cl. G05B 19/18; B25J 13/08; B25J 13/00; B23P 19/06

(52) U.S. Cl. CPC G05B 19/186; B23P 19/066; B25J 13/085; B25J 13/006; G05B 2219/45091

(57) ABSTRACT

A screw fastening device comprises a robot including a wrist part, a bit which turns a screw, a force sensor which detects force information associated with a force or a moment acting between the bit and the screw, and a controller which controls the robot. The wrist part includes a flange which rotates. The bit is supported by the flange so as to rotate coaxially with the rotation axis of the flange and rotates upon transmission of the rotational force of the flange.

### BACKGROUND OF THE INVENTION

1. Field of the Invention

The present invention relates to a screw fastening device comprising a robot.

2. Description of the Related Art

A device including a mechanism which turns a screw has been conventionally known to be used as an end effector attached to a robot. A screw is known to be fastened to a workpiece by adjusting the position and posture of the screw by the robot and turning the screw by the end effector. In such a robot and end effector, a screw fastening device which fastens a screw automatically while controlling the force applied to the end effector using a force sensor is known.

Japanese Unexamined Patent Publication No. H7-214435A discloses an automatic screw fastening device which sets a target posture for a bit on the same line as the vector of the force received by a screw fastening mechanism in fastening screw. This publication discloses screw is fastened while correcting the posture of the screw by feedback control of the posture of the bit on the basis of the output from a force sensor.

Japanese Unexamined Patent Publication No. 2010-264514A discloses an automatic screw fastening device comprising a force sensor mounted at the end of a robot arm, and a gripping and rotating device which is attached to the force sensor and rotates and drives a predetermined screwing component. It is disclosed that this automatic screw fastening device controls the end of the robot arm so as to adjust the axial external force detected by the force sensor to be a preset pressing force.

### SUMMARY OF THE INVENTION

In the screw fastening device disclosed in the above-described patent publication, an end effector for turning a screw is mounted at the distal end of the robot. Power to turn the screw is needed for the end effector. For example, a rotary machine which generates a rotational force such as an air motor or an electric motor is needed for the end effector. Further, a mechanism which converts a rotational force generated by the rotary machine into a desired rotational speed and a mechanism which rotates a tool about a desired rotation axis are needed for the end effector. This poses a problem that the end effector becomes large and heavy. Another problem is posed that the mechanism of the end effector becomes complex.

A screw fastening device according to the present invention comprises a robot including an arm and a wrist part including a connection member which connects an end effector and a drive source which rotates the connection member, and a tool which engages with a screw and turns the screw. The screw fastening device comprises a force detection mechanism which detects force information associated with a force or a moment acting between the tool and the screw. The screw fastening device comprises a controller which controls the robot so as to fasten the screw to a workpiece on the basis of the force information detected by the force detection mechanism. The tool is connected to the connection member so as to rotate coaxially with a rotation axis of the connection member. The tool rotates upon transmission of a rotational force of the connection member and fastens the screw to the workpiece.

In the above-mentioned invention, the force detection mechanism does not include wiring and a mechanism part which interferes with a rotational operation of the connection member and a portion fixed to the connection member can rotate integrally.

In the above-mentioned invention, the force detection mechanism may include a force sensor placed between the connection member and the tool and a wireless communication device for transmitting the force information detected by the force sensor to the controller. The wireless communication device may include a sending part placed so as to rotate integrally with the force sensor, and a reception part which is placed in a portion which does not rotate integrally with the force sensor and connected to the controller. The sending part can wirelessly transmit the force information to the reception part, and the reception part can transmit the received force information to the controller.

In the above-mentioned invention, the force detection mechanism may include a force sensor placed between the connection member and the tool and a slip ring for transmitting the force information detected by the force sensor to the controller. The slip ring includes a rotation part placed so as to rotate coaxially with the force sensor, and a fixing part connected to the controller. The force sensor can transmit the force information to the controller via the slip ring.

In the above-mentioned invention, the robot may include a plurality of rotation axes for changing a position and a posture of the wrist part. The force detection mechanism may include a torque sensor which detects a torque about the rotation axis. The controller can control the robot on the basis of output from the torque sensor.

In the above-mentioned invention, the screw fastening device may further comprise a power transmission device which rotates the tool using the rotational force of the connection member as a power source. The power transmission device may include an input shaft and an output shaft, and the input shaft can be fixed to the connection member and the tool can be fixed to the output shaft.

In the above-mentioned invention, the controller can control the robot so as to bring the force or the moment acting between the tool and the screw close to a predetermined value on the basis of the force information detected by the force detection mechanism.

In the above-mentioned invention, the controller can control the robot so as to bring the force pressing the tool in a traveling direction close to a predetermined value on the basis of the force information detected by the force detection mechanism.

In the above-mentioned invention, the controller can control the robot so as to bring a moment about an axis perpendicular to a direction in which the tool travels close to zero on the basis of the force information detected by the force detection mechanism.

In the above-mentioned invention, the controller can control the robot so as to bring the force in a direction perpendicular to a direction in which the tool travels close to zero on the basis of the force information detected by the force detection mechanism.

In the above-mentioned invention, the controller can end control for fastening the screw when a torque about a rotation axis of the tool satisfies a predetermined condition on the basis of the force information detected by the force detection mechanism.

Another screw fastening device according to the present invention comprises a robot including an arm and a wrist part including a connection member which connects an end effector and a drive source which rotates the connection member and an end effector including a claw part which holds a screw. The screw fastening device comprises a force detection mechanism which detects force information associated with a force or a moment acting between the screw and a female threaded part of a workpiece to which the screw is fastened. The screw fastening device comprises a controller which controls the robot so as to fasten the screw to the workpiece on the basis of the force information detected by the force detection mechanism. The claw part is configured to grip the screw so that a central axis of the screw is coaxial with a rotation axis of the connection member. The end effector is connected to the connection member. The end effector rotates upon transmission of a rotational force of the connection member and fastens the screw to a workpiece.

### BRIEF DESCRIPTION OF THE DRAWINGS

FIG. 1 is a schematic diagram of first screw fastening device in an embodiment.

FIG. 2 is an enlarged schematic diagram of a wrist part and an end effector of the first screw fastening device in the embodiment.

FIG. 3 is an enlarged schematic diagram of a wrist part and an end effector of second screw fastening device in the embodiment.

FIG. 4 is an enlarged schematic diagram of a wrist part and an end effector of third screw fastening device in the embodiment.

FIG. 5 is an enlarged schematic diagram of a wrist part and an end effector of fourth screw fastening device in the embodiment.

FIG. 6 is a block diagram related to the first screw fastening device to the fourth screw fastening device in the embodiment.

FIG. 7 is an enlarged perspective view of a bit and a screw in the embodiment.

FIG. 8 is a schematic diagram of fifth screw fastening device in the embodiment.

FIG. 9 is an enlarged schematic diagram of a wrist part and an end effector of the fifth screw fastening device in the embodiment.

FIG. 10 is a block diagram related to the fifth screw fastening device in the embodiment.

FIG. 11 is an enlarged schematic diagram of a wrist part and an end effector of sixth screw fastening device in the embodiment.

### DETAILED DESCRIPTION

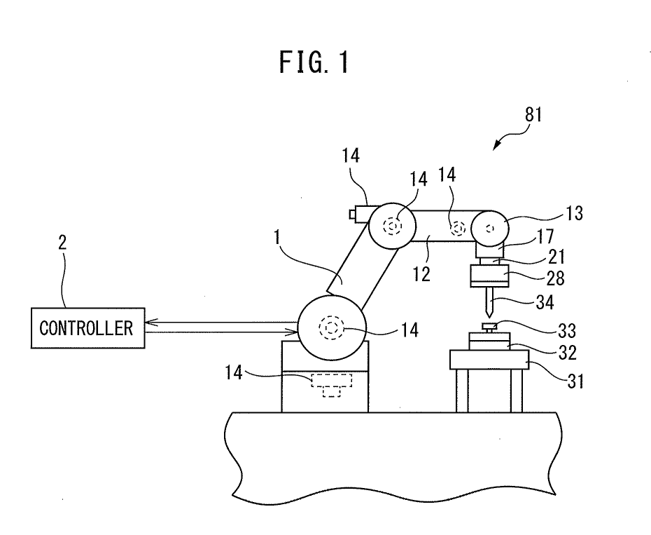

A screw fastening device in an embodiment will be described below with reference to FIG. 1 to FIG. 11. The screw fastening device according to the present embodiment turns a screw using a rotational force output from a robot so as to fasten the screw to a workpiece.

FIG. 1 is a schematic diagram of first screw fastening device in the present embodiment. A screw fastening device 81 performs a task for turning a bit 34 serving as a tool to fasten a screw 33 to a workpiece 32. The screw fastening device 81 comprises a robot 1 which changes the position and posture of the bit 34, and a controller 2 serving as a robot controller which controls the robot 1. The robot 1 is a six-axis vertical multi-articulated robot. In an example illustrated in FIG. 1, the workpiece 32 to which the screw 33 is fastened is placed on a base 31.

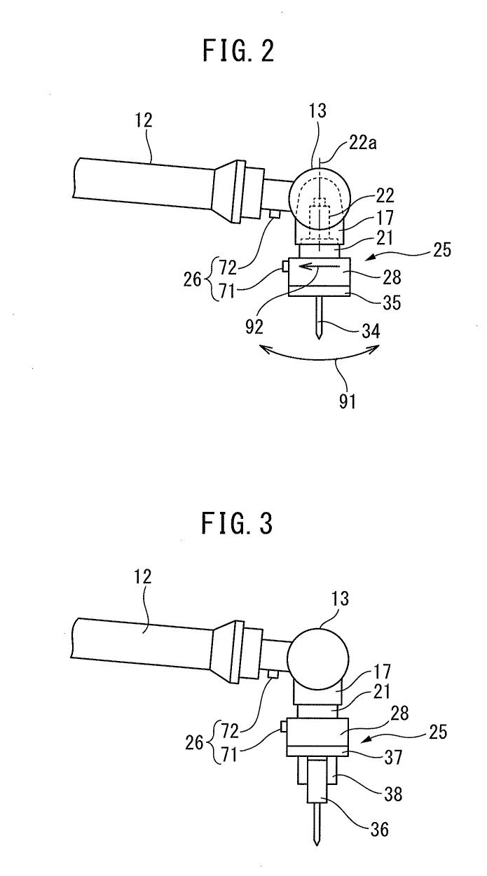

FIG. 2 shows an enlarged schematic diagram of a distal end part of a robot and an end effector of the first screw fastening device in the present embodiment. Referring to FIG. 1 and FIG. 2, a wrist part 17 is swingably formed around the rotation axis of a joint part 13 as indicated by an arrow 91. The wrist part 17 includes a flange 21 serving as a connection member which connects the end effector. The flange 21 is rotatable and its rotation axis 22a corresponds to a rotation axis located at the end of the robot 1. A flange drive motor 22 serving as a drive source which rotates the flange 21 is placed in the main body of the wrist part 17.

The first screw fastening device 81 includes a force sensor 28 fixed to the flange 21. The force sensor 28 is arranged between the flange 21 and the bit 34. As the force sensor 28, a six-axis force sensor capable of detecting forces in the directions of three orthogonal axes and moments about the three orthogonal axes can be employed. The force sensor 28 rotates together with the flange 21.

Although various types of force sensors such as one which uses a strain gauge, one which uses a change in electrostatic capacitance, and one which performs optical detection are available, any sensor may be used.

The bit 34 is fixed to the force sensor 28 through a bit holding member 35 serving as a tool holding member. In the first screw fastening device, the bit 34 and the bit holding member 35 constitute an end effector. The bit 34 corresponds to a tool which engages with the screw 33 and turns the screw 33. No bit holding member 35 may be arranged as long as the housing of the force sensor 28 is configured to hold the bit 34.

The bit 34 is fixed with its central axis coinciding with the rotation axis 22a of the flange 21. In other words, the central axis of the bit 34 and the rotation axis 22a of the flange 21 are coaxial with each other. Upon driving of the flange drive motor 22, the flange 21, the force sensor 28, the bit holding member 35, and the bit 34 rotate integrally as indicated by an arrow 92.

The bit 34 can turn the screw 33 by rotation upon transmission of the rotational force of the flange 21. The first screw fastening device 81 comprises a force detection mechanism 25 which detects force information associated with a force or a moment acting between the bit 34 and the screw 33. In the first screw fastening device 81, the force detection mechanism 25 includes the force sensor 28 and a wireless communication device 26 for transmitting the force information detected by the force sensor 28 to the controller 2. The wireless communication device 26 includes a sending part 71 placed on the force sensor 28 and a reception part 72 placed on an arm 12. The sending part 71 wirelessly transmits the force information detected by the force sensor 28 to the reception part 72. The reception part 72 transmits the received force information to the controller 2. Such wireless communication may use an arbitrary standard such as Bluetooth (registered trademark). As the force information, the value detected by the force sensor 28 may be transmitted to the controller 2 without conversion into, e.g., the force or the moment.

The sending part 71 can be attached to a portion which rotates integrally with the force sensor 28. The sending part 71 can be located in a portion which rotates with the rotational operation of the flange 21. The reception part 72 can be attached to a portion which does not rotate integrally with the force sensor 28. The reception part 72 can be located in a portion which does not rotate with the rotational operation of the flange 21. For example, the reception part 72 can be located in an arbitrary portion of the robot 1 other than the flange 21.

In the first screw fastening device, the force sensor 28 includes a storage battery inside. The force sensor 28 is driven by being supplied with electricity from the storage battery. The sending part 71 also sends force information by being supplied with electricity from the storage battery. Electricity supply to the force sensor 28 and the sending part 71 is not limited to this aspect, and a method for wirelessly supplying electricity, for example, may be employed.

The force detection mechanism 25 according to the present embodiment includes neither wiring nor a mechanism part which interferes with the rotational operation of the flange 21. The force sensor 28 fixed to the flange 21 and the bit 34 rotate integrally. Thus, for example, the flange 21 and the bit 34 can be rotated in plural number rotations so as to perform a screw fastening task at one time. On the other hand, when wiring and a mechanism part which interfere with the rotational operation of the flange 21 are provided, the process of rotating the screw at an angle which falls within the range in which the rotational operation is not interfered with can be repeated.

The force sensor 28 can detect force information associated with the force or the moment applied to the bit 34 by the screw 33. The controller 2 controls the position and the posture of the robot 1 so as to fasten the screw 33 to the workpiece 32 on the basis of the force information detected by the force detection mechanism 25. The controller 2 controls the position and the posture of the robot 1 so as to insert the bit 34 into a recess in the head part of the screw 33. The controller 2 drives the flange drive motor 22 to rotate the bit 34 about the rotation axis 22a, and controls the position and the posture of the robot 1 so as to press the bit 34 to the head part of the screw 33. With this control, the screw 33 can be fastened to the workpiece 32.

In this manner, the screw fastening device according to the present embodiment performs a screw fastening task using the rotational force on the end shaft of the robot as power. The screw fastening device according to the present embodiment does not need use the end effector including a motor for rotating the tool. This can achieve a smaller and more lightweight end effector.

A modification of the first screw fastening device will be described next. FIG. 3 shows an enlarged schematic diagram of a wrist part and an end effector of second screw fastening device in the present embodiment. In the second screw fastening device, the end effector is formed by a hand 37. The hand 37 is fixed to the surface of the force sensor 28 opposite to the side on which the flange 21 is placed. The hand 37 includes an openable and closable claw part 38. The claw part 38 is configured to enable gripping a driver 36 serving as a tool. The hand 37 is, for example, configured to be supplied with electricity by a storage battery. An operation instruction for driving the hand 37 can be received via the wireless communication device 26. For example, a sending part is placed on the arm 12 and a reception part is placed on the hand 37 so that an operation instruction can be sent from the controller 2 to the hand 37.

In this manner, the hand 37 in which the claw part 38 can be driven may be used as a tool holding member which holds a tool. With this configuration, the type of the driver 36 can be changed during a period of screw fastening control. A plurality of types of screw fastening tasks can be continuously performed.

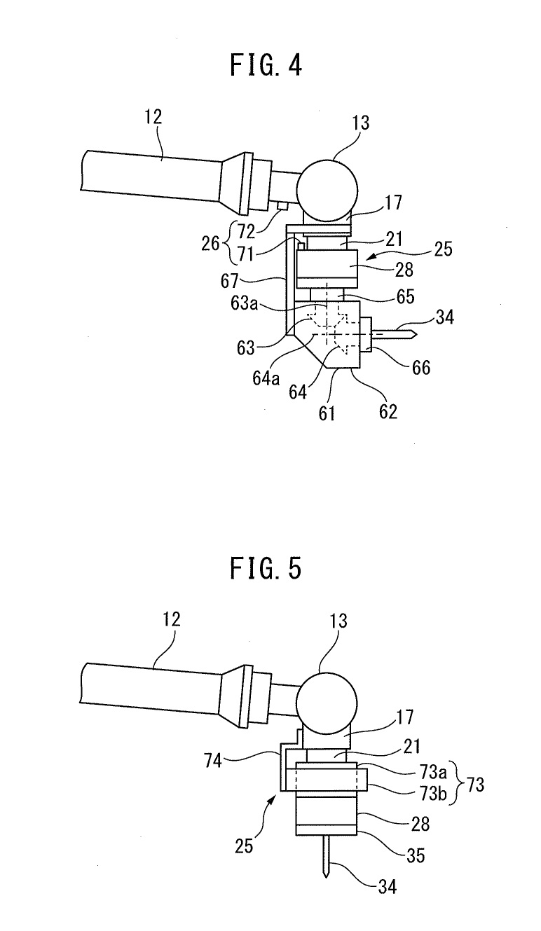

FIG. 4 shows an enlarged schematic diagram of a wrist part and an end effector of third screw fastening device in the present embodiment. The end effector of the third screw fastening device comprises a power transmission device which rotates a tool using the rotational force of a flange 21 as a power source. The force sensor 28 is fixed to the flange 21. A power transmission device 61 is connected to the force sensor 28.

The power transmission device 61 includes a casing 62 and bevel gears 63 and 64 placed in the casing 62. The power transmission device 61 includes an input shaft 65 and an output shaft 66. The input shaft 65 is fixed to the force sensor 28. The bevel gear 63 is connected to the input shaft 65. The force sensor 28, the input shaft 65, and the bevel gear 63 integrally rotate about a rotation axis 63a. The power transmission device 61 is placed so that the rotation axis 63a is coaxial with a rotation axis 22a of the flange 21.

The bevel gear 64 engages with the bevel gear 63. The bevel gear 64 is connected to the output shaft 66 to which the bit 34 is fixed. The bevel gear 64, the output shaft 66, and the bit 34 integrally rotate about a rotation axis 64a.

The casing 62 is supported by the wrist part 17 through a casing support member 67. Hence, the casing 62 is configured to not to rotate upon rotation of the flange 21. Upon driving of the flange drive motor 22, the flange 21, the force sensor 28, and the input shaft 65 rotate. The rotation axis is converted by the bevel gears 63 and 64. The power transmission device 61 can rotate the bit 34 about the rotation axis 64a.

In this manner, the direction of the rotation axis of a tool can be changed by a power transmission device. As the power transmission device, not only a mechanism which changes the direction of the rotation axis but also an arbitrary mechanism which transmits a rotational force may be employed. For example, the power transmission device may include a decelerator which increases the torque of the bit.

FIG. 5 shows an enlarged schematic diagram of a wrist part and an end effector of fourth screw fastening device in the present embodiment. The fourth screw fastening device is different from the first screw fastening device with regard to the transmission mechanism for the force information detected by the force sensor 28. A force detection mechanism 25 of the fourth screw fastening device includes the force sensor 28 placed between a flange 21 and a bit 34 and a slip ring 73 for transmitting the force information detected by the force sensor 28 to a controller 2. The slip ring 73 according to the present embodiment is placed between the flange 21 and the force sensor 28.

The slip ring 73 includes a cylindrical rotation member 73a serving as a rotation part, and a fixing member 73b serving as a fixing part which rotatably supports the rotation member 73a at inside. The rotation member 73a is placed so as to rotate coaxially with the force sensor 28. The fixing member 73b is supported by the main body of the wrist part 17 on a support member 74. The flange 21 and the force sensor 28 are fixed to the rotation member 73a. The rotation member 73a rotates by the rotation of the flange 21.

The slip ring 73 serves as a device which performs communication and electricity supply between the fixing member 73b and the rotation member 73a. For example, an electrode is placed on the surface of the rotation member 73a. A brush which comes into contact with the electrode is placed on the fixing member 73b. Electricity and signals can be transmitted by the contact between the electrode and the brush.

A power line which supplies electricity and a communication line which transmits signals is fixed to the support member 74. The slip ring 73 can transmit force information output from the force sensor 28 to the main body of the robot 1 via the communication line fixed to the support member 74. In the force detection mechanism 25 of the fourth screw fastening device, force information output from the force sensor 28 can be transmitted to the controller 2 via the slip ring 73. In other words, the fixing member 73b of the slip ring 73 is electrically connected to the controller 2. Electricity can be supplied from the main body of the robot 1 to the force sensor 28 by fixing the power line to the support member 74. Portions fixed to the flange 21 can integrally rotate in plural number of rotations. In this manner, the use of a slip ring can eliminate wiring and a mechanism part which interfere with the rotational operation of the flange.

Control of the screw fastening device in the present embodiment will be described next. Although the first screw fastening device will be described by taking as an example here, the same control may also be performed for the second screw fastening device to the fourth screw fastening device.

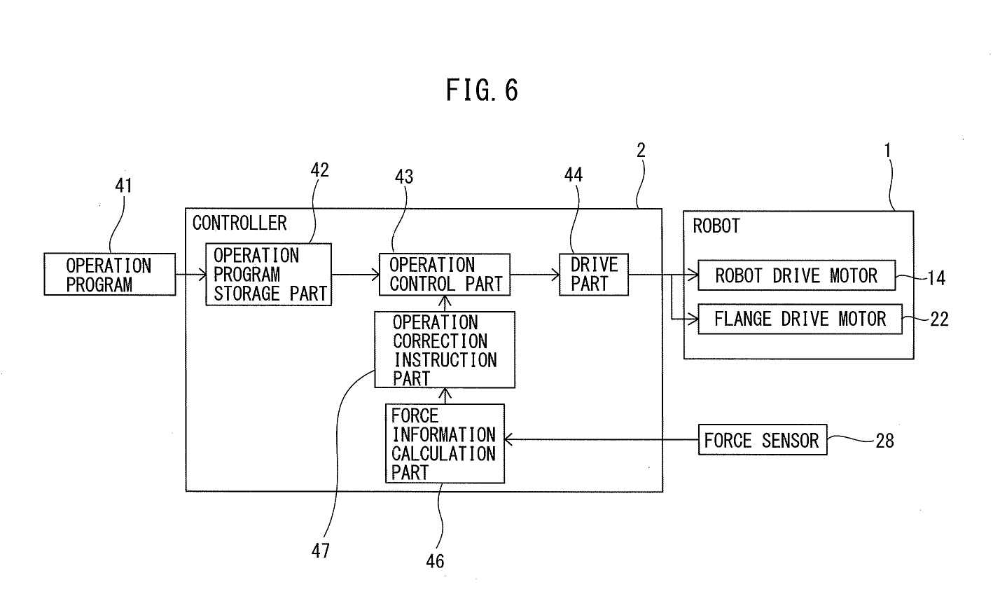

FIG. 6 shows a block diagram related to the first screw fastening device to the fourth screw fastening device in the present embodiment. The controller 2 includes an arithmetic processing device including, e.g., a CPU (Central Processing Unit), a RAM (Random Access Memory), and a ROM (Read Only Memory) connected to each other via buses. Referring to FIG. 1, FIG. 2, and FIG. 6, the screw fastening device 81 is configured to drive the robot 1 on the basis of an operation program 41. An operation program 41 defined in advance for the operation of the robot 1 is input to the controller 2. The operation program 41 is stored in an operation program storage part 42. An operation control part 43 sends an operation instruction for driving the robot 1 on the basis of the operation program 41 to a drive part 44. The drive part 44 includes an electrical circuit which drives a robot drive motor 14 and a flange drive motor 22. The drive part 44 supplies electricity to the robot drive motor 14 and the flange drive motor 22 on the basis of the operation instruction.

The controller 2 includes a force information calculation part 46 which receives force information output from the force sensor 28. The force information calculation part 46 calculates the force in a predetermined direction and a moment (torque) about a predetermined rotation axis on the basis of a signal output from the force sensor 28.

The position and the posture of the force sensor 28 according to the present embodiment changes upon the operation of the robot during the period of a screw fastening task. The position and the posture of the force sensor 28 can be calculated on the basis of the position and the posture of a coordinate system for the distal end of the wrist part, and the information on a relative position of the force sensor relative to the distal end of the wrist part. The force information calculation part 46 can calculate the magnitude of the force or the moment in a preset arbitrary coordinate system and the direction of the force or the moment on the basis of the position, the posture, and the output value of the force sensor 28.

The controller 2 includes an operation correction instruction part 47 which generates an instruction for correcting the position and the posture of the wrist part of the robot 1 on the basis of the information calculated by the force information calculation part 46. The operation correction instruction part 47 sends the correction instruction of the position and the posture of the wrist part of the robot 1 to the operation control part 43. The operation control part 43 corrects the position and the posture of the wrist part of the robot 1 on the basis of the correction instruction. Control of the robot 1 according to the present embodiment may employ any method such as impedance control. The controller 2 according to the present embodiment controls the robot so as to bring the force or the moment acting between the tool and the screw close to a predetermined value on the basis of the force information detected by the force detection mechanism 25.

In first control according to the present embodiment, the robot 1 is controlled so as to bring the force pressing the tool in the traveling direction close to a predetermined value on the basis of the force information detected by the force detection mechanism 25.

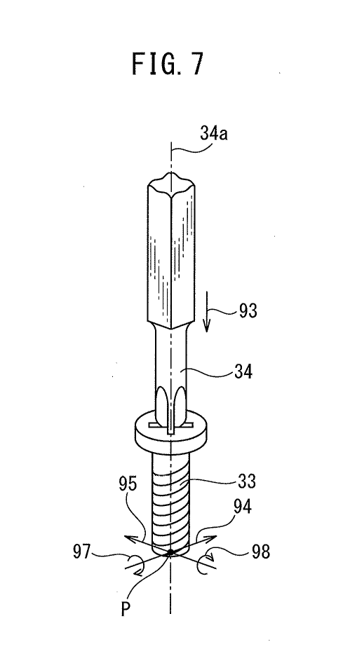

FIG. 7 shows an enlarged perspective view of a portion where a bit and a screw engage with each other in the present embodiment. The bit 34 and the screw 33 rotate about a rotation axis 34a. For example, in the first screw fastening device, the rotation axis 34a coincides with the rotation axis 22a of the flange 21. The robot 1 applies the force pressing the bit 34 toward the screw 33 as indicated by an arrow 93 in performing a task of fastening the screw 33. In the screw fastening task, when the force applied in the direction in which the screw travels becomes short, a phenomenon called come-out in which the bit 34 slips off the head part of the screw 33 occurs. On the other hand, when the force pressing the screw 33 is too large, the threads of the female threaded part of the workpiece 32 may break.

Therefore, in the first control, control is performed so as to bring the force applied to the bit 34 by the robot 1 along the rotation axis 34a close to a predetermined value. This set value is preferably a large value to the extent that a come-out phenomenon does not occur and is a small value to the extent that the female threaded part is not broken. The predetermined set value may be designated within the range of the force.

Referring to FIG. 6, the force sensor 28 detects a reaction force from the screw 33 in the rotation axis 34a, i.e., the force to press the bit 34. The controller 2 stores, a set value for the force to press the bit 34 in advance. The force information calculation part 46 detects the force to press the bit 34. When, for example, the force to press the bit 34 is larger than the set value, the operation correction instruction part 47 sends a correction instruction to correct the position and the posture of the wrist part of the robot 1 in the direction in which the bit 34 is away from the screw 33. The operation control part 43 corrects the position and the posture of the wrist part of the robot 1. By conducing this control, the breakage of the female threaded part and the come-out phenomenon can be suppressed. Conducting this control can improve the rate of success of screw fastening tasks.

In second control according to the present embodiment, the controller 2 controls the robot so as to bring the moment about an axis perpendicular to the direction in which the tool travels close to zero on the basis of the force information detected by the force detection mechanism 25.

Referring to FIG. 7, an axis perpendicular to the rotation axis 34a is selected at the tip of the screw 33 on the rotation axis 34a as the axis perpendicular to the direction in which the bit 34 travels. For example, two axes which pass through a tip point P of the screw 33 and are orthogonal to each other are selected as indicated by an arrow 94 and an arrow 95. The force information calculation part 46 can calculate moments about the axes set as indicated by an arrow 97 and an arrow 98 on the basis of the output from the force sensor 28. The operation correction instruction part 47 sends a correction instruction of the position and the posture of the wrist part of the robot 1 to the operation control part 43 so as to bring the detected moments close to zero. Thus, the operation control part 43 can correct the position and the posture of the wrist part of the robot 1.

By conducting the second control, the tilt of the central axis of the male screw with respect to the central axis of the female threaded part can be brought close to zero. In other words, the position and the posture of the bit 34 can be controlled so that the central axis of the female threaded part and the central axis of the male screw are parallel with each other. This can enhance the rate of success of screw fastening tasks.

In third control according to the present embodiment, the controller 2 controls the robot so as to bring the force in a direction perpendicular to a direction in which the tool travels close to zero on the basis of the force information detected by the force detection mechanism 25. Referring to FIG. 7, a direction perpendicular to the rotation axis 34a can be selected at an arbitrary point on the rotation axis 34a. For example, two directions which pass through the tip point P of the screw 33 and are orthogonal to each other are selected as indicated by the arrow 94 and the arrow 95 in the same way as the second control. The force information calculation part 46 can calculate forces applied to the screw 33 in the selected directions on the basis of the output from the force sensor 28. The operation correction instruction part 47 sends a correction instruction of the position and the posture of the wrist part of the robot 1 to the operation control part 43 so as to bring the calculated forces close to zero. Thus, the operation control part 43 can correct the position and the posture of the wrist part of the robot 1. In the third control, a direction perpendicular to the rotation axis 34a can be selected at an arbitrary point on the rotation axis 34a, without limitation to the tip point P of the screw 33.

By conducting the third control, the shift in position of the male screw and the female threaded part in a direction perpendicular to a direction of the rotation axis 34a of the bit 34 can be brought close to zero. In other words, the position and the posture of the wrist part of the robot 1 can be corrected so that the position of the central axis of the male screw coincide with the position of the central axis of the female screw. This can enhance the rate of success of screw fastening tasks.

In fourth control according to the present embodiment, the controller 2 ends control for fastening the screw, when a torque about a rotation axis of the tool satisfies a predetermined condition on the basis of the force information detected by the force detection mechanism 25. For example, the force information calculation part 46 detects a torque about the rotation axis 34a of the bit 34 on the basis of the output from the force sensor 28. In other words, the force information calculation part 46 detects a reaction torque applied to the bit 34 by the screw 33. The operation correction instruction part 47 can judge that satisfactory fastening has been achieved when the detected torque is larger than a predetermined judgement value. The operation correction instruction part 47 sends an instruction to end control for fastening the screw to the operation control part 43. The operation control part 43 can end the screw fastening task on the basis of this instruction.

By conducting the fourth control, the torque for fastening the screw can be adjusted to a desired magnitude. In other words, it is possible to avoid the situation in which the torque for fastening the screw is weak or strong.

The above-mentioned force detection mechanism includes the force sensor 28 supported by the flange 21 of the wrist part 17. The force detection mechanism is not limited to this aspect, and an arbitrary mechanism which detects force information on the force or the moment acting between the tool and the screw may be employed. Other aspects of the force detection mechanism will be described next.

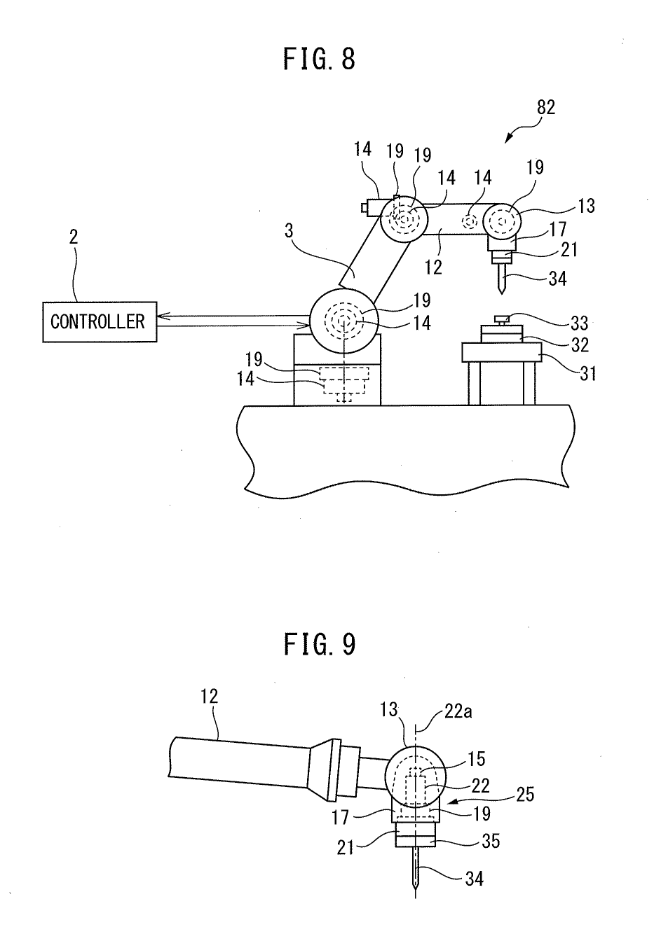

FIG. 8 shows a schematic diagram of fifth screw fastening device in the present embodiment. The fifth screw fastening device 82 comprises a robot 3. The robot 3 includes a torque sensor 19 which detects a torque about each rotation axis. The robot 3 is a six-axis vertical multi-articulated robot.

FIG. 9 shows an enlarged schematic diagram of a wrist part and an end effector of the fifth screw fastening device in the present embodiment. Referring to FIG. 8 and FIG. 9, a torque sensor 19 which detects a torque occurring about a rotation axis 22a is placed in the main body of a wrist part 17. In this manner, the robot 3 of the fifth screw fastening device is formed so that torques about all rotation axes can be individually detected. In the fifth screw fastening device, a bit holding member 35 is fixed to a flange 21 of the wrist part 17. The fifth screw fastening device is configured so that no force sensor is placed between the flange 21 and a bit 34.

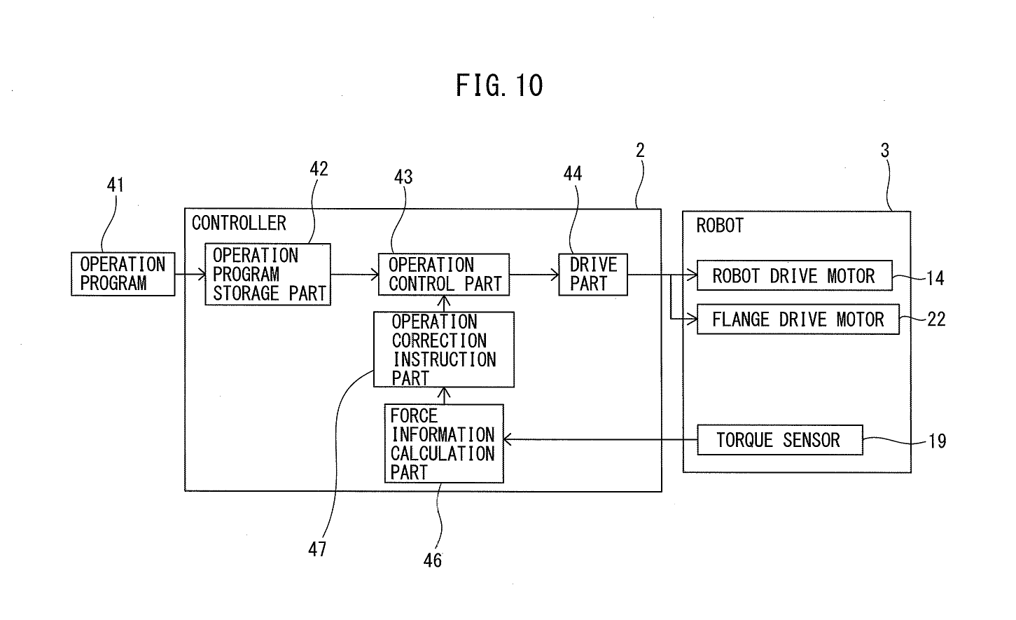

FIG. 10 shows a block diagram of the fifth screw fastening device in the present embodiment. Referring to FIG. 8 to FIG. 10, a force detection mechanism 25 of the fifth screw fastening device 82 includes a torque sensor 19 which detects a torque about the rotation axis of the robot 3. In the robot 3 of the fifth screw fastening device, torque sensors 19 are arranged for all rotation axes. Force information output from the torque sensor 19 is input to the force information calculation part 46 of the controller 2.

The force information calculation part 46 calculates the force or the moment acting between the tool and the screw on the basis of the information associated with the torque detected by the torque sensor 19. The force information calculation part 46 can calculate the force or the moment in a desired direction by obtaining output from the torque sensor 19. In this manner, the force detection mechanism 25 may include a torque sensor placed on each rotation axis of the robot. Other configurations and controls are the same as those in the above-mentioned screw fastening devices, i.e., the first screw fastening device to the fourth screw fastening device.

In the above-described embodiment, the robot rotates the tool, but the present invention is not limited to this aspect. Hands may be attached to the robots 1, 3 and grip screws. A screw fastening task can be performed by turning the screws using the robots 1, 3.

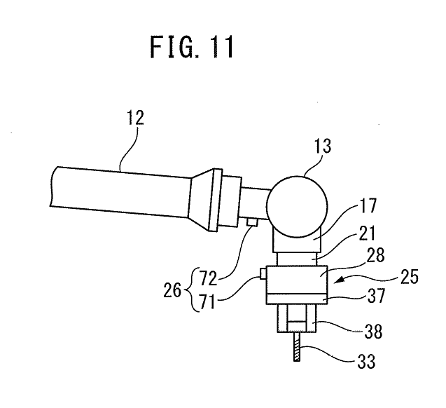

FIG. 11 shows an enlarged schematic diagram of a portion of a wrist part and an end effector of sixth screw fastening device in the present embodiment. The sixth screw fastening device is configured to grip a screw in place of gripping a tool in the second screw fastening device (see FIG. 3) according to the present embodiment. In the following description, an example in which a hand grips and fastens a male screw to a female threaded part of a workpiece will be given, but also a case where a hand grips and fastens a component including a female threaded part to a male threaded part of a workpiece can be realized with the same method.

The force sensor 28 is fixed to a flange 21 of a wrist part 17. A hand 37 is fixed to the force sensor 28. A claw part 38 of the hand 37 is shaped to enable holding a screw 33. The hand 37 is configured to enable gripping and releasing the screw 33 by the claw part 38. The claw part 38 grips the screw 33 so that a rotation axis 22a of the flange 21 is coaxial with the central axis of the screw 33. The hand 37 rotates upon transmission of the rotational force of the flange 21. The screw 33 rotates about the central axis upon rotation of the flange 21. A screw fastening task can be performed as the robot 1 brings the screw 33 into contact with a female threaded part of a workpiece 32 while turning the screw 33.

In the sixth screw fastening device, the screw 33 can be turned by the robot 1 without using a tool. Control is performed at this time in the same way as the above-mentioned control which uses a tool. A force detection mechanism 25 detects force information associated with the force or the moment acting between the screw 33 and the female threaded part to which the screw 33 is fastened. For example, the force detection mechanism 25 can detect force information on the basis of the output from the force sensor 28. The controller 2 can control the robot 1 so as to fasten the screw 33 to the workpiece 32 on the basis of the force information. For example, the controller 2 can calculate the force or the moment applied to the screw in place of the tool so as to perform the same control as the above-mentioned controls, i.e., the first control to the fourth control.

In the sixth screw fastening device, the force detection mechanism 25 includes the force sensor 28 fixed to the flange 21, but the present invention is not limited to this aspect, and the force detection mechanism 25 may include a torque sensor placed on the rotation axis of the robot in the same way as the fifth screw fastening device. In this case, referring to FIG. 9, a hand 37 including an openable and closable claw part 38 can be fixed to the flange 21 instead of the bit holding member 35 and the bit 34. Other configurations and controls of the sixth screw fastening device are the same as those of the above-mentioned screw fastening devices.

Note that in the sixth screw fastening device, a screw 33 is indicated as a fastening member gripped by the hand, but the present invention is not limited to this aspect, and a nut may be gripped in place of the screw. A task for fastening a nut to a male threaded part of a workpiece can be performed with the same configuration and control as the sixth screw fastening device.

In the present embodiment, the force or the moment is calculated by the force information calculation part 46 of the controller 2, but the present invention is not limited to this aspect, and, for example, the force sensor 28 or the torque sensor 19 may include an arithmetic processing device including a CPU. In other words, the force information calculation part 46 may be placed in the torque sensor 19 or the force sensor 28. The operation correction instruction part 47 can send an instruction to correct the operation of the robot 1, 3 on the basis of the force or the moment calculated by the torque sensor 19 or the force sensor 28.

The robot according to the present embodiment is a six-axis vertical multi-articulated robot, but the present invention is not limited to this aspect, and any robot whose position and posture are controllable may be employed. For example, the robot does not need to have six axes or may include a linear axis used to drive an arm.

The present invention can provide the screw fastening device including a small and lightweight end effector.

The above-described embodiments may be combined as appropriate. In each of the above-described drawings, the same reference signs denote the same or equivalent parts. The above-described embodiments are illustrative and are not intended to limit the invention. Further, the embodiments include changes thereof defined in the scope of claims.

1. A screw fastening device comprising:
a robot which includes an arm and a wrist part including a connection member which connects an end effector and a drive source which rotates the connection member;
a tool which engages with a screw and turns the screw;
a force detection mechanism which detects force information associated with a force or a moment acting between the tool and the screw; and
a controller which controls the robot so as to fasten the screw to a workpiece on the basis of the force information detected by the force detection mechanism, wherein
the tool is connected to the connection member so as to rotate coaxially with a rotation axis of the connection member, rotates upon transmission of a rotational force of the connection member, and fastens the screw to the workpiece.

2. The screw fastening device according to claim 1, wherein the force detection mechanism includes neither wiring nor a mechanism part which interfere with a rotational operation of the connection member and a portion fixed to the connection member rotates integrally.

3. The screw fastening device according to claim 1, wherein
the force detection mechanism includes a force sensor placed between the connection member and the tool, and a wireless communication device for transmitting the force information detected by the force sensor to the controller,
the wireless communication device includes a sending part placed so as to rotate integrally with the force sensor and a reception part which is placed in a portion which does not rotate integrally with the force sensor and connected to the controller,
the sending part wirelessly transmits the force information to the reception part, and
the reception part transmits the received force information to the controller.

4. The screw fastening device according to claim 1, wherein
the force detection mechanism includes a force sensor placed between the connection member and the tool, and a slip ring for transmitting the force information detected by the force sensor to the controller,
the slip ring includes a rotation part placed so as to rotate coaxially with the force sensor and a fixing part connected to the controller, and
the force sensor transmits the force information to the controller via the slip ring.

5. The screw fastening device according to claim 1, wherein
the robot includes a plurality of rotation axes for changing a position and a posture of the wrist part,
the force detection mechanism includes a torque sensor which detects a torque about the rotation axis, and
the controller controls the robot on the basis of output from the torque sensor.

6. The screw fastening device according to claim 1, further comprising a power transmission device which rotates the tool using the rotational force of the connection member as a power source, wherein
the power transmission device includes an input shaft and an output shaft, and
the input shaft is fixed to the connection member and the tool is fixed to the output shaft.

7. The screw fastening device according to claim 1, wherein the controller controls the robot so as to bring the force or the moment acting between the tool and the screw close to a predetermined value on the basis of the force information detected by the force detection mechanism.

8. The screw fastening device according to claim 1, wherein the controller controls the robot so as to bring the force to press the tool in a traveling direction close to a predetermined value on the basis of the force information detected by the force detection mechanism.

9. The screw fastening device according to claim 1, wherein the controller controls the robot so as to bring the moment about an axis perpendicular to a direction in which the tool travels close to zero on the basis of the force information detected by the force detection mechanism.

10. The screw fastening device according to claim 1, wherein the controller controls the robot so as to bring the force in a direction perpendicular to a direction in which the tool travels close to zero on the basis of the force information detected by the force detection mechanism.

11. The screw fastening device according to claim 1, wherein the controller ends control for fastening the screw when the torque about a rotation axis of the tool satisfies a predetermined condition on the basis of the force information detected by the force detection mechanism.

12. A screw fastening device comprising:
a robot including an arm and a wrist part including a connection member which connects an end effector and a drive source which rotates the connection member;
an end effector including a claw part which holds a screw;
a force detection mechanism which detects force information associated with a force or a moment acting between the screw and a female threaded part of a workpiece to which the screw is fastened; and
a controller which controls the robot so as to fasten the screw to the workpiece on the basis of the force information detected by the force detection mechanism, wherein
the claw part is configured to grip the screw so that a central axis of the screw is coaxial with a rotation axis of the connection member, and
the end effector is connected to the connection member, rotates upon transmission of a rotational force of the connection member, and fastens the screw to a workpiece.
